(19) United States
(12) Patent Application Publication
(10) Pub. No.: US 2007/0014240 A1
(43) Pub. Date: Jan. 18, 2007

(54) Using locks to coordinate processing of packets in a flow

(76) Inventors: Alok Kumar, Santa Clara, CA (US); Santosh Balakrishnan, Gilbert, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/180,938

(22) Filed: Jul. 12, 2005

(51) Int. Cl. H04L 12/26

(52) U.S. Cl. 370/231

(57) ABSTRACT

In general, in one aspect, the disclosure describes a method that includes accessing a first set of bits from data associated with a flow identifier of a packet and accessing flow data based on the first set of bits. The method also includes accessing a second set of bits from the data associated with the flow identifier of the packet and accessing lock data based on the second set of bits.

### BACKGROUND

Networks enable computers and other devices to communicate. For example, networks can carry data representing video, audio, e-mail, and so forth. Typically, data sent across a network is divided into smaller messages known as packets. By analogy, a packet is much like an envelope you drop in a mailbox. A packet typically includes “payload” and a “header”. The packet's “payload” is analogous to the letter inside the envelope. The packet's “header” is much like the information written on the envelope itself. The header can include information to help network devices handle the packet appropriately. For example, the header can include an address that identifies the packet's destination.

A given packet may “hop” across many different intermediate network forwarding devices (e.g., “routers”, “bridges” and/or “switches”) before reaching its destination. These intermediate devices often perform a variety of packet processing operations. For example, intermediate devices often determine how to forward a packet further toward its destination and/or a quality of service to provide.

Network devices are carefully designed to keep apace the increasing volume of traffic traveling across networks. Some architectures implement packet processing using “hard-wired” logic such as Application Specific Integrated Circuits (ASICs). While ASICs can operate at high speeds, changing ASIC operation, for example, to adapt to a change in a network protocol can prove difficult.

Other architectures use programmable devices known as network processors. Network processors enable software programmers to quickly reprogram network operations. Some network processors feature multiple processing cores to amass packet processing computational power. These cores may operate on packets in parallel. For instance, while one core determines how to forward one packet further toward its destination, a different core determines how to forward another. This enables the network processors to achieve speeds rivaling ASICs while remaining programmable.

### BRIEF DESCRIPTION OF THE DRAWINGS

FIGS. 1A-1C are diagrams illustrating operation of threads using mutual-exclusion locks.

FIG. 2 is a diagram illustrating hashing of a flow identifier to determine location of flow and lock data.

FIG. 3 is a diagram of a multi-core processor.

FIG. 4 is a diagram of a network forwarding device.

### DETAILED DESCRIPTION

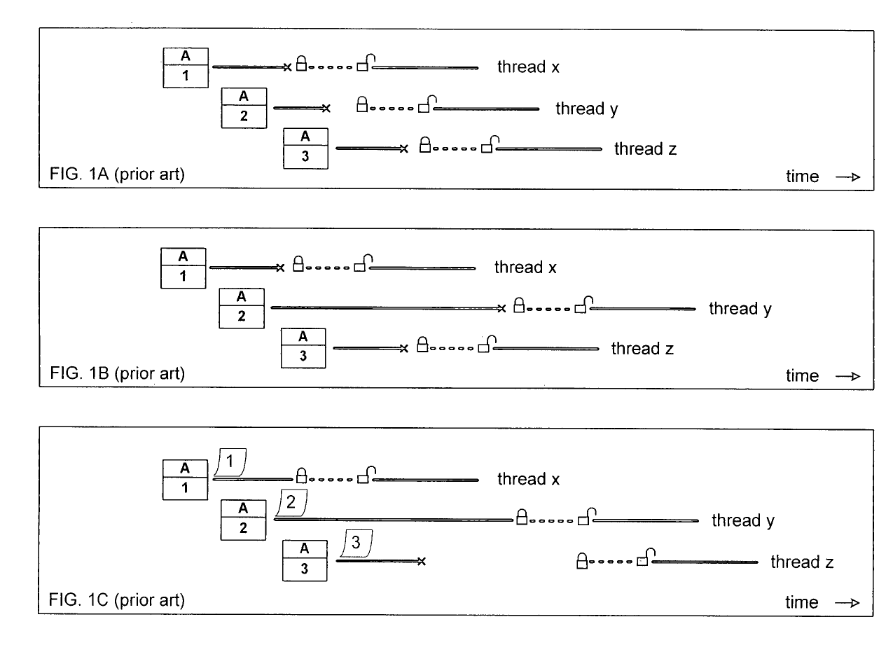

Network processors typically provide multiple threads that run in parallel. In many systems, the network processors are programmed such that different threads independently process different packets. For example, FIG. 1A depicts a scheme where different packet processing threads (x, y, z) process different packets (1, 2, 3). For instance, each thread may determine how to forward a given packet further towards its network destination. As shown, the packets are assigned to available threads as they arrive.

Potentially, as illustrated in FIG. 1A, these different packets may belong to the same flow (e.g., flow “a”). For example, the packets may share the same source/destination pair, be part of the same TCP (Transmission Control Protocol) connection, or the same ATM (Asynchronous Transfer Mode) circuit. Typically, a given flow has associated state data that is updated for each packet. For example, in TCP, a Transmission Control Block (TCB) describes the current state of a TCP connection. Since packets 1, 2, 3 belong to the same flow, without some safeguards, threads x, y, z could potentially attempt to modify the same flow data at the same time, potentially, causing flow data errors/incoherence.

As shown in FIG. 1A, to coordinate access to the shared flow data, the threads can use a lock (depicted as a combination lock). The lock provides a mutual exclusion mechanism that ensures only a single thread can access lock protected data/code at a time. That is, if a lock is owned by one thread, attempts to acquire the lock are denied and/or queued.

Thus, as shown in FIG. 1A, before a thread attempts to access flow data shared by the threads, the thread attempts to acquire (illustrated as an “x”) the protecting lock. Potentially, the thread may stop operation until the lock is acquired or may proceed to execute thread instructions not dependent on access to the flow data. Eventually, after acquiring the lock, the thread can perform whatever operations are needed before releasing the lock with the assurance that no other thread is accessing the data protected by the lock at the same time. A typical use of a lock is to create a “critical section” of instructions—code that is only executed by one thread at a time (shown as a dashed line in FIGS. 1A-1C). Entry into the critical section is often controlled by a “wait” or “enter” routine that only permits subsequent instructions to be executed after acquiring a lock. For example, in FIG. 1A, a thread's critical section may read, modify, and write-back flow data for a packet's connection. More specifically, as shown, thread x first acquires the lock, then executes lock protected code for packet 1, and finally releases the lock. After thread x releases the lock, waiting thread y can acquire the lock, execute the protected code for packet 2, and release the lock, followed likewise by thread z for packet 3.

In the example of FIG. 1A, the threads requested the locks in the same order in which packets arrived and likewise executed the critical section in the same sequence. Potentially, however, processing time may vary for different packets. This varying processing time, among other possible factors, may cause the execution order of critical sections to vary from the order in which packets arrive. For example, in FIG. 11B thread y takes a long time to process packet 2, relative to threads x and z, before attempting to acquire the lock for the flow data. Thus, as shown, thread z may execute the critical section for packet 3 before thread y executes the critical section for packet 2. This failure to perform the critical section code in the order of packet receipt may violate a system's design requirement. For example, in a system that reassembles ATM packets (“cells”) into an AAL-5 (ATM Adaptation Layer) frame, determination of CRC (Cyclic Redundancy Check) residue for each cell depends on correct computation of the CRC for the immediately preceding cell in the circuit. As another example, a network processor may be used to implement a stateful firewall that maintains packet states for each flow. If these states are not updated in order, the states will become inconsistent and may inhibit proper operation of the firewall.

To preserve the packet-receipt-order of critical section execution, FIG. 1C depicts a “deli ticket” scheme where threads can request a place in a locking sequence. For example, as shown in FIG. 1C, threads x, y, and z request a place in a locking sequence (shown as “deli tickets” labeled “1”, “2”, and “3”) soon after being assigned packets. Continuing the “deli” analogy, the threads then await their deli ticket number to be “called” before entering a critical section. As shown, despite the varying processing times, threads x, y, and z process packets 1, 2, and 3 in the order of arrival.

An implementation of the “deli” scheme shown in FIG. 1C may use lock data that includes a pair of counters: a head-of-line counter and a tail-of-line counter. When a packet arrives to be processed by a thread, the thread obtains the current tail-of-line counter value and increments the tail-of-line counter (e.g., thread y gets ticket #2 and sets the tail-of-line counter to #3 for assignment to the next requesting thread). For example, thread y can issue an atomic test_and_incr command to the counter register. After receiving the old value of tail-of-line counter, the thread can compare it with the head-of-line counter until the counters are equal. Alternately, the thread may receive a signal indicating it has reached the head of the line. At that point, having acquired the lock, the thread enters the critical section and updates the flow data. After the update is done, the thread increments the head-of-line counter which allows subsequent threads in the locking sequence to process a packet from the same flow.

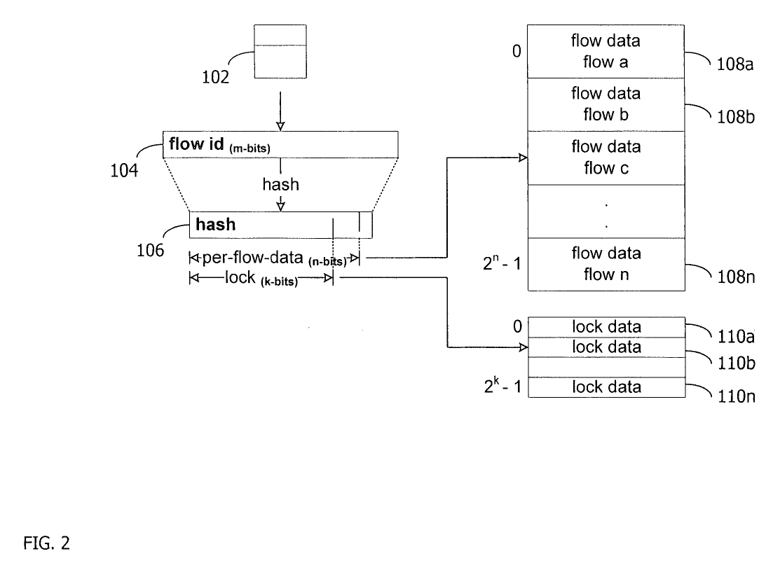

The deli-ticket scheme shown in FIG. 1C maintained the order that threads accessed lock protected data. However, storing the two counters for each flow can consume a considerable amount of memory when multiplied by the large number of flows that typically travel through a network device. As an alternative to a 1:1 ratio of locks to flows, a system may use a single global pair of counters for all flows (e.g., a 1:NumFlows ratio). This greatly reduces the amount of memory used to store lock data, but can lead to severe inefficiency when a delay in one flow introduces a bottleneck in the processing of all flows handled by the device. FIG. 2 illustrates a sample implementation of a technique that can balance memory space usage versus performance efficiency when using locks for ordered mutual exclusion. Briefly, the scheme provides a N:NumFlows ratio of locks to flows where some, but not all, flows share a lock. Adjusting “N” also adjusts the balance between memory usage by the locks and the performance penalty for using a given lock for multiple flows.

As shown in FIG. 2, a flow id 104 is determined for a packet, for example, by concatenating one or more fields in a packet's header(s). For example, a flow id for an ATM cell may include an ATM circuit identifier. Alternately, for an IP packet encapsulating a TCP segment, the flow id may be a combination of the IP source and destination addresses and the source and destination ports identified in the TCP segment header.

As shown, the flow id 104 may undergo a hash operation to yield a hash number 106 typically smaller than the number of bits (e.g., m) of the flow-id. The resultant hash 106 can then be used to access flow data (e.g., flow state, metering data, CRC residue, and so forth) and lock data (e.g., a semaphore, pair of “deli-ticket” counters, and so forth). For example, A first set of bits (e.g., the first n-bits) of the hash can be used as an index into a hash table of flow data 108a-108n while a second, smaller set of bits (e.g., the first k-bits) of the hash can be used as an index into a hash table of lock data 110a-110n. In this example, fewer flow locks (e.g., 2k) are available than the number of flows/flow data entries available (e.g., 2n). Thus, a collision involving multiple flows hashing to the same lock entry 110x is a very small but existent probability. In other words, the system trades memory space usage for some probability that different flows may become execution sequence dependent when they may have been able to be processed in parallel if greater lock availability was provided. This tradeoff can be tuned by changing the number of bits used to identify a lock entry. That is, fewer bits saves memory but increases the likelihood of flow collisions while more bits uses more memory.

In the example shown in FIG. 2, the k-bits of the lock index were a subset of the n-bits of the flow data index. However, this is not a requirement. That is, the k-bits and n-bits may be mutually exclusive. Additionally, the set of k-bits and/or set of n-bits need not be consecutive bits within the hash value 106.

The lock 110 and flow data 108 may be stored in hash tables as shown. Potentially, these hash tables may be stored in different memory (e.g., the lock data in SRAM and the per-flow data in DRAM). Additionally, while FIG. 2 depicted the lock 110 and flow data 108 as hash tables, other data storage designs may be used.

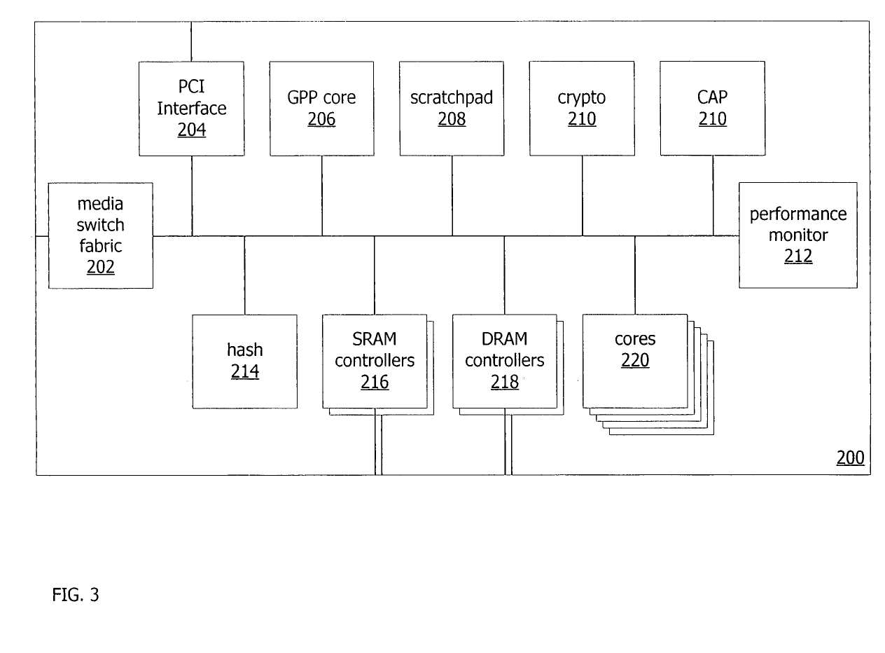

The locking techniques describe above can be implemented in a variety of ways and in different environments. For example, the techniques may implemented as a computer program for execution by a multi-threaded processor such as a network processor. As an example, FIG. 3 depicts an example of network processor 200 that can be programmed to process packets using the techniques describe above. The network processor 200 shown is an Intel®Internet eXchange network Processor (IXP). Other processors feature different designs.

The network processor 200 shown features a collection of programmable processing cores 220 (e.g., programmable units) on a single integrated semiconductor die. Each core 220 may be a Reduced Instruction Set Computer (RISC) processor tailored for packet processing. For example, the cores 220 may not provide floating point or integer division instructions commonly provided by the instruction sets of general purpose processors. Individual cores 220 may provide multiple threads of execution. For example, a core 220 may store multiple program counters and other context data for different threads.

As shown, the network processor 200 also features an interface 202 that can carry packets between the processor 200 and other network components. For example, the processor 200 can feature a switch fabric interface 202 (e.g., a Common Switch Interface (CSIX)) that enables the processor 200 to transmit a packet to other processor(s) or circuitry connected to a switch fabric. The processor 200 can also feature an interface 202 (e.g., a System Packet Interface (SPI) interface) that enables the processor 200 to communicate with physical layer (PHY) and/or link layer devices (e.g., MAC or framer devices). The processor 200 may also include an interface 204 (e.g., a Peripheral Component Interconnect (PCI) bus interface) for communicating, for example, with a host or other network processors.

As shown, the processor 200 includes other components shared by the cores 220 such as a cryptography core that aids in cryptographic operations, internal scratchpad memory 208 shared by the cores 220, and memory controllers 216, 218 that provide access to external memory shared by the cores 220. The network processor 200 also includes a general purpose processor 206 (e.g., a StrongARM® XScale® or Intel Architecture core) that is often programmed to perform “control plane” or “slow path” tasks involved in network operations while the cores 220 are often programmed to perform “data plane” or “fast path” tasks.

The cores 220 may communicate with other cores 220 via the shared resources (e.g., by writing data to external memory or the scratchpad 208). The cores 220 may also intercommunicate via neighbor registers directly wired to adjacent core(s) 220. The cores 220 may also communicate via a CAP (CSR (Control Status Register) Access Proxy) 210 unit that routes data between cores 220. The different components may be coupled by a command bus that moves commands between components and a push/pull bus that moves data on behalf of the components into/from identified targets.

Each core 220 can include a variety of memory resources such as local memory and general purpose registers. A core 220 may also include read and write transfer registers that store information being sent to/received from components external to the core and next neighbor registers that store information being directly sent to/received from other cores 220. The data stored in the different memory resources may be used as operands in the instructions and may also hold the results of datapath instruction processing. The core 220 may also include a command queue that buffers commands (e.g., memory access commands) being sent to targets external to the core.

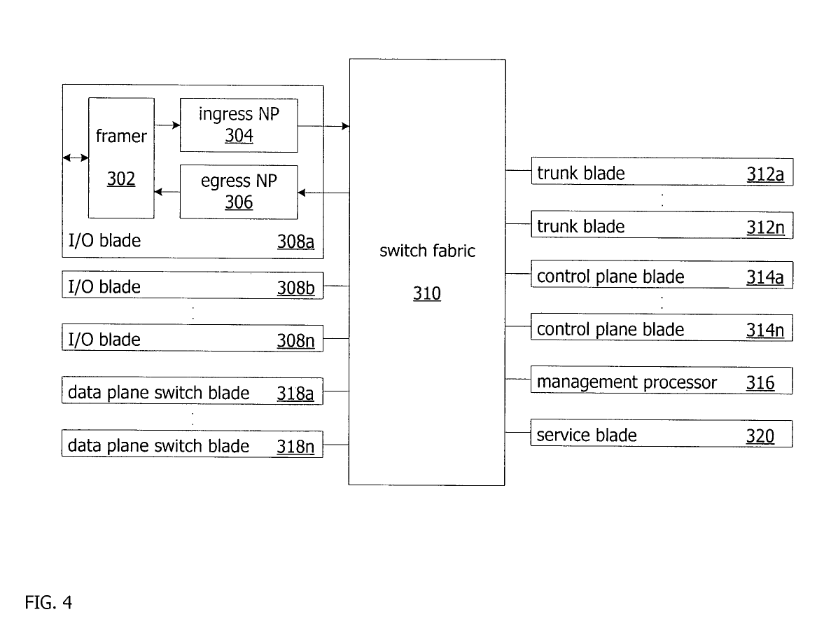

FIG. 4 depicts a network device that can process packets using the lock scheme described above. As shown, the device features a collection of blades 308-320 holding integrated circuitry interconnected by a switch fabric 310 (e.g., a crossbar or shared memory switch fabric). As shown the device features a variety of blades performing different operations such as I/O blades 308a-308n, data plane switch blades 318a-318b, trunk blades 312a-312b, control plane blades 314a-314n, and service blades. The switch fabric, for example, may conform to CSIX or other fabric technologies such as HyperTransport, Infiniband, PCI, Packet-Over-SONET, RapidIO, and/or UTOPIA (Universal Test and Operations PHY Interface for ATM).

Individual blades (e.g., 308a) may include one or more physical layer (PHY) devices (not shown) (e.g., optic, wire, and wireless PHYs) that handle communication over network connections. The PHYs translate between the physical signals carried by different network mediums and the bits (e.g., “0”-s and “1”-s) used by digital systems. The line cards 308-320 may also include framer devices (e.g., Ethernet, Synchronous Optic Network (SONET), High-Level Data Link (HDLC) framers or other “layer 2” devices) 302 that can perform operations on frames such as error detection and/or correction. The blades 308a shown may also include one or more network processors 304, 306 that perform packet processing operations for packets received via the PHY(s) and direct the packets, via the switch fabric 310, to a blade providing an egress interface to forward the packet. Potentially, the network processor(s) 306 may perform “layer 2” duties instead of the framer devices 302. The network processors 304, 306 may be programmed to implement the locking techniques described above.

While FIGS. 3-4 described specific examples of a network processor and a device incorporating network processors, the techniques may be implemented in a variety of architectures including processors and devices having designs other than those shown. Additionally, the techniques may be used in a wide variety of network devices (e.g., a router, switch, bridge, hub, traffic generator, and so forth).

Other embodiments are within the scope of the following claims.

What is claimed is:

1. A method, comprising:
accessing a first set of bits from data associated with a flow identifier of a packet;
accessing flow data based on the first set of bits;
accessing a second set of bits from the data associated with the flow identifier of the packet, the second set of bits being fewer in the number of bits than the first set of bits;
accessing lock data based on the second set of bits.

2. The method of claim 1,
wherein the data associated with the flow identifier comprises a hash of the flow identifier;
wherein the first set of bits comprises an index into a hash table of flow data; and
wherein the second set of bits comprises an index into a hash table of lock data.

3. The method of claim 1, wherein the data associated with a flow identifier comprises bits of the flow identifier.

4. The method of claim 1, wherein the lock data comprises at least one selected from the following group:
a semaphore; and
a pair of counters including a head-of-line counter and a tail-of-line counter.

5. The method of claim 1,
wherein accessing the first set of bits, accessing flow data, accessing the second set of bits, accessing the lock data comprises accessing the first set of bits, accessing flow data, accessing the second set of bits, and accessing the lock data by a thread provided by a processor having multiple multi-threaded programmable cores integrated on a single die.

6. The method of claim 5,
wherein the thread comprises a thread assigned to process the packet.

7. The method of claim 6,
wherein the thread comprises one of multiple threads processing packets of a flow; and
wherein the multiple threads gain mutually exclusive access to the flow data by acquiring a lock using the lock data.

8. The method of claim 1,
wherein the flow identifier comprises at least one selected from the following group:
at least one field of a Transmission Control Protocol (TCP) segment header;
at least one field of an Internet Protocol (IP) datagram header; and
at least one field of an Asynchronous Transfer Mode (ATM) cell header.

9. A computer program, disposed on a computer readable medium, comprising instructions for causing a processor to when executed:
access a first set of bits of a hash of a flow identifier of a packet;
access flow data using the first set of bits as an index into a flow data hash table;
access a second set of bits of the hash of the flow identifier of the packet, the second set of bits being fewer in the number of bits than the first set of bits; and
access lock data using the second set of bits as an index into a lock data hash table.

10. The program of claim 9, wherein the lock data comprises at least one selected from the following group:
a semaphore; and
a pair of counters including a head-of-line counter and a tail-of-line counter.

11. The program of claim 9,
wherein instructions to access the first set of bits, access flow data, access the second set of bits, access the lock data comprise instructions to access the first set of bits, access flow data, access the second set of bits, and access the lock data by a thread provided by a processor having multiple multi-threaded programmable cores integrated on a single die.

12. The program of claim 11,
wherein the thread comprises one of multiple threads processing packets of a flow; and
wherein the multiple threads gain mutually exclusive access to the flow data by acquiring a lock using the lock data.

13. The program of claim 9,
wherein the second set of bits is a subset of the first set of bits.

14. A network forwarding device, comprising:
a switch fabric;
multiple blades interconnected by the switch fabric, at least one of the multiple blades having a processor having multiple multi-threaded cores integrated on a single die, multiple ones of the cores programmed to:
access a first set of bits of a hash of a flow identifier of a packet;
access flow data using the first set of bits as an index into a flow data hash table;
access a second set of bits of the hash of the flow identifier of the packet, the second set of bits being fewer in the number of bits than the first set of bits;
access lock data using the second set of bits as an index into a lock data hash table; and
acquire mutually exclusive access to the flow data relative to other threads processing packets of a flow using the lock data.

15. The device of claim 14, wherein the lock data comprises at least one selected from the following group:
a semaphore; and
a pair of counters including a head-of-line counter and a tail-of-line counter

16. The device of claim 14, wherein the first set of bits is a subset of the second set of bits.
